(19) United States
(12) Patent Application Publication
(10) Pub. No.: US 2012/0168562 A1
(43) Pub. Date: Jul. 5, 2012

(54) DEVICE FOR CONTROLLING TRAPDOORS CLOSING THE HOLD OF AIRCRAFT LANDING GEAR

(75) Inventors: Christian Alonzo, Chilly Mazarin (FR); Chris Bryant, Pickering (CA); Arnaud Launay, Levis Saint Nom (FR); Frederic Rouchouse, Paris (FR)

(73) Assignee: MESSIER-BUGATTI-DOWTY, Velizy-Villacoublay (FR)

(21) Appl. No.: 13/381,847

(22) PCT Filed: Jul. 5, 2010
(86) PCT No.: PCT/EP10/59594

§ 371 Date: Mar. 23, 2012

(30) Foreign Application Priority Data
Jul. 3, 2009 (FR) 09 03273

(51) Int. Cl. B64C 25/20

(52) U.S. Cl. 244/102 A

(57) ABSTRACT

A device for driving at least one door (4a, 4b) of an aircraft undercarriage bay, the device comprising a permanent mechanical linkage (20, 23, 24, 25a, 25b) between the door and the undercarriage. The permanent linkage is arranged to transform a movement of the undercarriage between a stowed position and a deployed position, or vice versa, into a go-and-return movement suitable for causing the door to open and then to close during the movement of the undercarriage between said positions.

The invention relates to a device for driving the doors that close the bay of an aircraft undercarriage.

### TECHNOLOGICAL BACKGROUND OF THE INVENTION

In general, the undercarriage and the doors of the corresponding bay are driven by distinct actuators. Sequential logic means guarantee that the doors open before the undercarriage is moved, and then that the doors close. In certain aircraft, such as the DC3, the doors of the main undercarriages are urged towards the open position by a resilient member that holds the doors open when the undercarriage is in the deployed position. On the undercarriage being raised, it docks with a catcher connected to the doors by links and then entrains it, thereby causing the doors to be closed against the resilient member while the undercarriage is terminating its stroke. On the undercarriage being lowered, the resilient member forces the catcher to follow the undercarriage as it moves, thereby causing the doors to open. At a given position in the stroke of the undercarriage, the catcher meets an abutment, and therefore ceases to move, such that the doors then remain stationary in the open position while the undercarriage continues to move towards the deployed position. Such an arrangement enables the door drive actuator to be omitted, but it does not enable the doors to be closed while the undercarriage is in the deployed position.

Documents U.S. Pat. No. 2,406,710 and U.S. Pat. No. 2,452,251 disclose devices in accordance with the introduction of claim 1, in which the movement of the undercarriage between a stowed position and a deployed position is used by a permanent mechanical linkage between the door and the undercarriage to impart a go-and-return movement on the door.

In document U.S. Pat. No. 2,406,710, a toothed sector is used to rotate a generator lever that is hinged to the structure of the aircraft, which lever, by rotating through a complete turn during the movement of the undercarriage, imparts the looked-for go-and-return movement to the door.

In document U.S. Pat. No. 2,452,251, the undercarriage causes a generator lever that is hinged to the structure of the aircraft to pivot firstly in one direction and then in the other.

### OBJECT OF THE INVENTION

The invention seeks to provide a simple device for driving doors, which device enables the doors to be closed at the end of the movement of the undercarriage.

### BRIEF SUMMARY OF THE INVENTION

In order to achieve this object, the invention provides a device for driving at least one door of an aircraft undercarriage bay, the device comprising a permanent mechanical linkage coupled to the door and to the undercarriage and arranged to transform a movement of the undercarriage between a stowed position and a deployed position, or vice versa, into a go-and-return movement suitable for opening and then closing the door during the movement of the undercarriage between said positions. According to the invention, the permanent linkage comprises a generator lever hinged to an element of the undercarriage and coupled to a stationary point of the aircraft so as to present a go-and-return movement relative to the undercarriage element.

Thus, the undercarriage itself is used as a source of movement that is transformed into go-and-return movement by the permanent mechanical linkage so as to act on the door and thereby close the doors every time after the undercarriage has been moved. Naturally, care should be taken to ensure that during the movement of the undercarriage, the door opens sufficiently early and closes sufficiently late to avoid any risk of the undercarriage and the door coming into contact.

The generator lever is hinged to the undercarriage, thereby considerably simplifying the design of the bay, since there is no need to provide a hinge on its structure.

In addition, the mechanism remains very simple, being based on links and levers, and there are no actuators to be controlled.

### BRIEF DESCRIPTION OF THE FIGURES

The invention can be better understood in the light of the following description of the figures of the accompanying drawings, in which:

FIG. 1 is a perspective view of an undercarriage fitted with a door-drive device of the invention, the undercarriage being shown in the deployed position;

FIG. 2 is a perspective view of the FIG. 1 undercarriage, here shown while being raised;

FIG. 3 is a perspective view of the FIG. 1 undercarriage, here shown in the stowed position; and

FIG. 4 is a perspective view of the mechanical linkage of the door-drive device fitted to the undercarriage shown in FIGS. 1 to 3.

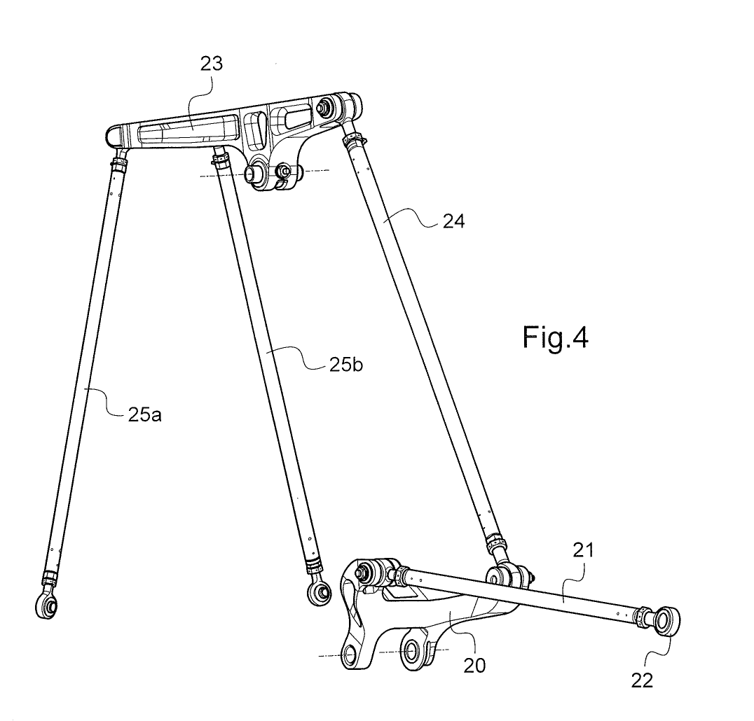

### DETAILED DESCRIPTION OF THE FIGURES

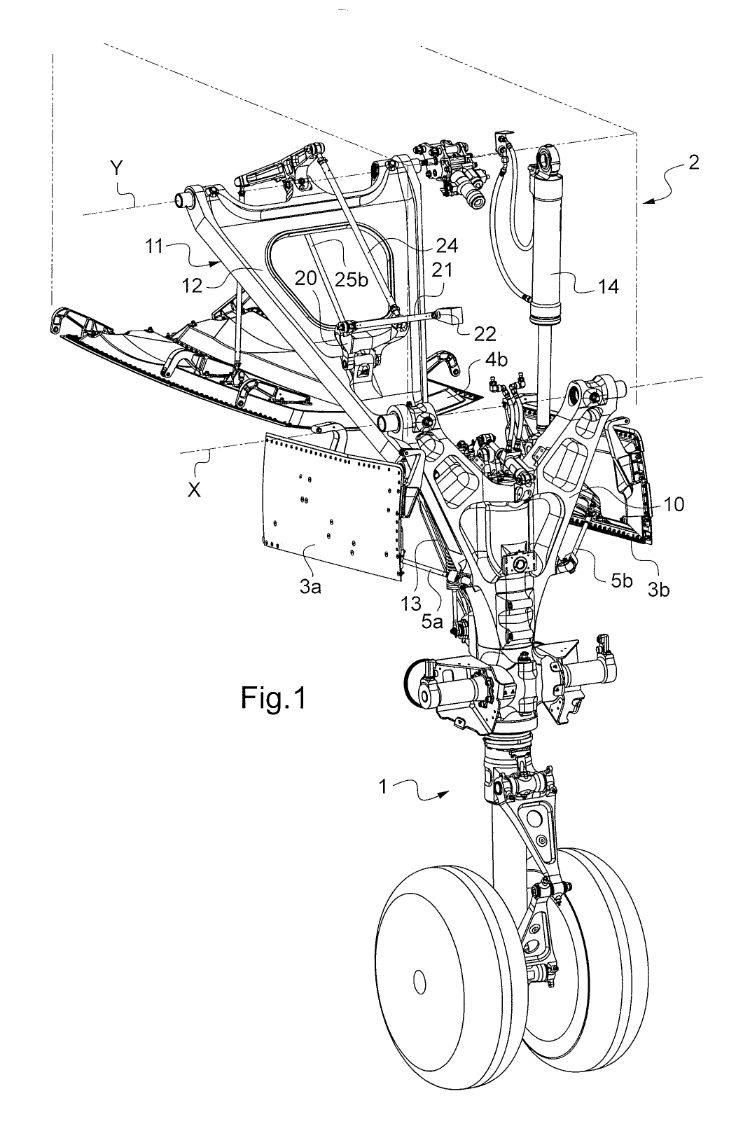

As can be seen in FIGS. 1 to 3, the invention is described herein for the particular configuration of an undercarriage 1 having a bay 2 that is closed by four doors referenced respectively 3a & 3b and 4a & 4b. In this example, all four doors 3a, 3b, 4a, 4b are hinged along a respective longitudinal edge to the structure of the aircraft.

The doors 3a and 3b have drive systems that are different from the doors 4a and 4b. The doors 3a and 3b remain open after the undercarriage 1 reaches its deployed position so as to enable the leg of the undercarriage to project from the aircraft, while the doors 4a and 4b reclose once the undercarriage reaches its deployed position so as to reclose the bay 2 to a large extent.

It is known to make the doors 3a and 3b move by coupling each of them to the leg of the undercarriage using a respective single link 5a, 5b. Thus, the movement of the undercarriage from the stowed position to the deployed position (or vice versa from the deployed position to the stowed position) is transmitted to the doors 3a, 3b so that they move from the closed position to the open position (or vice versa from the open position to the closed position).

According to the invention, the continuous movement of the undercarriage towards one or the other of its positions is used to generate go-and-return actuation for the doors 4a, 4b.

For reasons of explanation, it is recalled that the undercarriage 1 shown comprises a leg 10 that is hinged to the structure of the aircraft about a horizontal hinge axis X. It is associated with a breaker strut 11 comprising an upper panel 12 hinged to the structure of the aircraft about an axis Y parallel to the hinge axis X of the leg 10. The panel 12 is coupled to the leg 10 by an arm 13 that is hinged to the panel 12 and to the leg 10 about axes parallel to the hinge axis X. A stabilizer member holds the panel 12 and the arm 13 in a substantially aligned position when the undercarriage is in the deployed position, thereby stabilizing the leg 10 and thus the undercarriage, in the deployed position. In order to raise the undercarriage, a driving actuator 14 coupled to the leg 10 and also to the structure of the aircraft pulls on the leg 10 so that once the stabilizer member has been unlocked, the undercarriage is raised up to the stowed position. During this movement, the alignment of the panel 12 and of the arm 13 is broken and the breaker strut folds. This is well known and is recalled merely for the purpose of describing the invention.

It should be observed that when the undercarriage moves from one of its positions to the other, the panel 12 of the strut 10 performs rotary motion continuously, without reversing. According to the invention, this movement without reversing is used to generate a go-and-return movement that serves to open and close the doors 4a, 4b.

For this purpose, and as can be seen more particularly in FIG. 1, the panel 12 of the strut is fitted with a generator lever 20 mounted to turn on the panel about a hinge axis parallel to the axis X. A retaining link 21 connects the generator lever 20 to a stationary point 22 of the aircraft structure. The generator lever 20 transmits its motion to a rocker lever 23 also pivotally mounted on the panel 12, by means of a transmission rod 24. The rocker lever 23 has two links 25a, 25b coupled thereto and coupled respectively to the door 4a and to the door 4b.

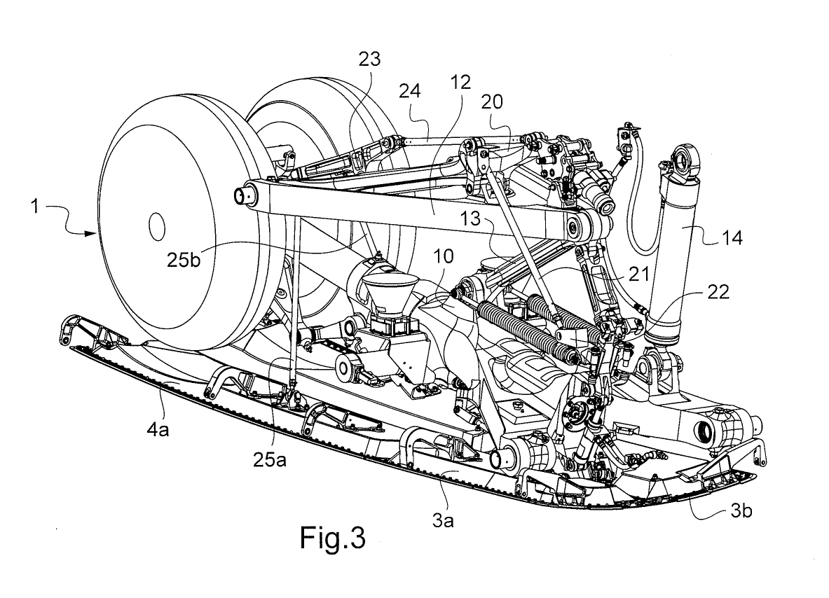

The above-described assembly provides a permanent mechanical linkage between the undercarriage and the doors 4a, 4b, which linkage operates as follows. Starting from the stowed position shown in FIG. 3, the undercarriage leg begins to move down towards its deployed position by pivoting about the axis X. In so doing, the panel 12 itself pivots, thereby causing the generator lever 20 to pivot so that it tends to move closer to the panel 12. This movement is transmitted to the rocker lever 23 by the transmission rod 24, thus causing the rocker lever to pivot in a direction that tends to push against the links 25a and 25b, and thus open the doors 4a and 4b.

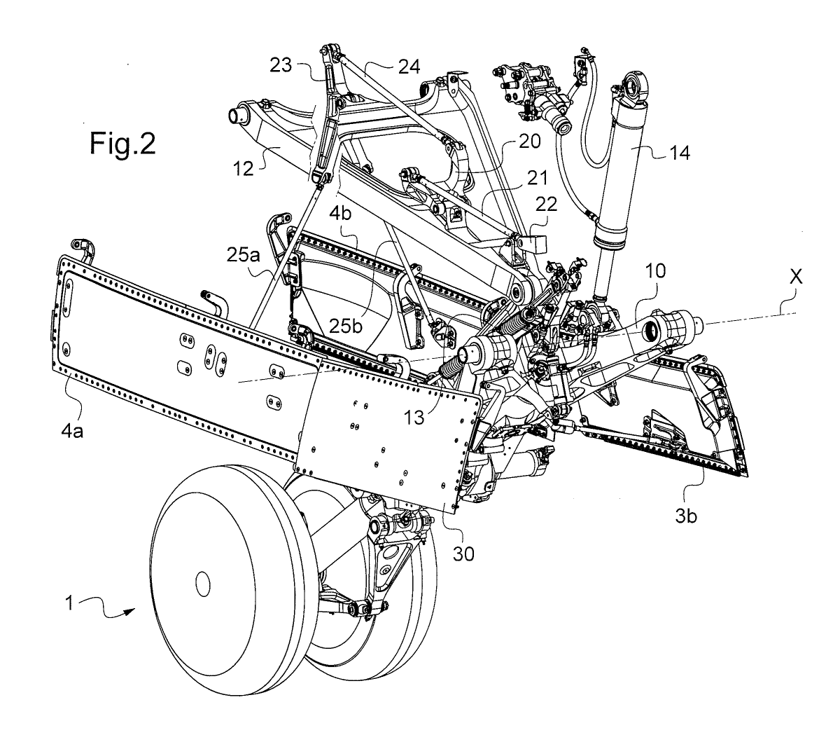

The doors 4a and 4b thus open progressively so as to allow the wheels that are carried by the undercarriage to pass between them. The pivoting movement of the undercarriage leg and of the panel 12 continues to the position shown in FIG. 2 in which the panel 12 and the retaining link extend substantially parallel. This position corresponds substantially to the closest the generator lever 20 comes to the panel 12, and thus corresponds substantially to the maximally-open position of the doors 4a, 4b.

As the movement continues, the generator lever 20 then begins to move in the opposite direction relative to the panel 12, moving away therefrom, while the panel 12 continues its movement in rotation in the same direction. This about-turn is then transmitted by the rod 24 to the rocker lever 23, which pivots in the opposite direction so as to pull the links 25a and 25b and thus cause the doors 4a and 4b to close. When the undercarriage reaches the deployed position, the doors are closed and bear against their abutments. The device is designed in such a manner that a certain amount of tension is maintained in the links 25a and 25b when the doors 4a and 4b are in the closed position.

Naturally, when the undercarriage is raised towards its stowed position, the doors 4a and 4b move in the opposite manner. They therefore begin by opening until the undercarriage reaches the intermediate position of FIG. 2, after which they close when the undercarriage reaches the stowed position. Once more, a certain amount of tension is maintained in the links 25a and 25b when the doors 4a and 4b are in the closed position.

Thus, the permanent mechanical linkage of the invention transforms continuous pivoting motion without reversal of the panel 12 of the strut 11 into a go-and-return movement generated by the generator lever 20, and transmitted to the doors 4a and 4b so that they open and close each time the undercarriage passes from one position to the other.

The invention is not limited to the above description, but on the contrary covers any variant coming within the ambit defined by the claims.

In particular, although, in the example shown, the generator lever of the permanent mechanical linkage is connected to a stationary point of the structure of the aircraft, that stationary point is not essential, and other linkages could be designed within the ambit of the invention, not requiring such a stationary point. For example, the retaining link could be coupled to the leg of the undercarriage, or to any other part of the undercarriage, providing such an arrangement serves to generate the go-and-return movement that is needed for opening and closing the doors.

In addition, in the ambit of the invention, it is possible to envisage omitting the rocker lever, providing it is possible to couple the doors directly to the generator lever.

Naturally, other permanent mechanical linkages between the undercarriage and the doors could be used, providing they generate a reciprocating go-and-return movement suitable for opening and then closing the doors (or the door if there is only one of them) of the undercarriage bay. For example, a crank could be provided that is connected to the doors by means of a link, the crank being constrained to rotate with one of the pivoting elements of the undercarriage with an appropriate velocity ratio by means of a link, gearing, or any other rotary connection. As is well known, a crank is suitable for transforming a continuous rotary movement into a reciprocating movement that can be used for opening and closing the door(s).

What is claimed is:

1. A device for driving at least one door (4a, 4b) of an aircraft undercarriage bay, the device comprising a permanent mechanical linkage (20, 23, 24, 25a, 25b) coupled to the door and to the undercarriage and arranged to transform a movement of the undercarriage between a stowed position and a deployed position, or vice versa, into a go-and-return movement suitable for opening and then closing the door during the movement of the undercarriage between said positions, wherein the permanent linkage comprises a generator lever (20) hinged to an element (12) of the undercarriage and coupled to a stationary point (22) of the aircraft so as to present a go-and-return movement relative to the undercarriage element.

2. A device according to claim 1, wherein the go-and-return movement of the generator lever (20) is transmitted to a rocker lever (23), also pivotally mounted on the undercarriage element, the rocker lever being coupled to the door.
